(19) United States
(12) Patent Application Publication
(10) Pub. No.: US 2026/0121129 A1
(43) Pub. Date: Apr. 30, 2026

(54) LEAKAGE DETECTION LIQUID COLLECTOR AND BATTERY LEAKAGE DETECTION SYSTEM INCLUDING SAME

(71) Applicants: AJOU UNIVERSITY INDUSTRY-ACADEMIC COOPERATION FOUNDATION, Suwon-si (KR); KOREA MIDLAND POWER CO., LTD., Boryeong-si (KR)

(72) Inventors: Baek YOUN, Suwon-si (KR); Pyongwan PARK, Seoul (KR); Jun Hyuk LEE, Suwon-si (KR); Donghyuk KIM, Gunsan-si (KR)

(21) Appl. No.: 19/006,977

(22) Filed: Dec. 31, 2024

(30) Foreign Application Priority Data
Jul. 4, 2024 (KR) 10-2024-0088415

(51) Int. Cl. H01M 10/42; H01M 50/60; H01M 50/691

(52) U.S. Cl. CPC H01M 10/4228; H01M 50/668; H01M 50/691

(57) ABSTRACT

A leakage detection liquid collector for detecting fluid leakage from a battery module according to the present disclosure includes: a collection unit coupled to the bottom of a battery module and having a downward sloping surface formed toward the central portion to form a collection space where leaked fluid is gathered at the central portion, a support plate provided between the battery model and the collection unit to support the load of the battery module, and a sensing unit provided inside the collection unit to detect the fluid collected in the collection space.

### CROSS REFERENCE TO RELATED APPLICATION(S) OF THE DISCLOSURE

The present application claims the priority and benefit of Korean Patent Application No. 10-2024-0088415, filed on Jul. 4, 2024, with the Korean Intellectual Property Office, the entire contents of which are incorporated herein by reference.

### BACKGROUND OF THE DISCLOSURE

### Field of the Disclosure

The present disclosure relates to a leakage detection liquid collector and a battery leakage detection system including the same, and more specifically, a leakage detection liquid collector which can collect and detect fluid leaking from a battery module to prevent degradation in battery performance or accidents caused by the leakage.

### Background Art

Lithium-ion batteries, which are most commonly used in battery energy storage systems (BESSs), are significantly affected by temperature in terms of performance, durability, and safety.

If the battery temperature is high (above 30° C.) or there is a significant temperature difference within the battery (above 10° C.), it negatively impacts the battery's safety and durability.

Thus, an efficient battery thermal management system is required to maintain a proper temperature (25° C.±a).

Most BESS thermal management systems currently commercialized in Korea are air-cooled. The air-cooled BESS is an energy storage system which cools the battery through forced convection of cold air via a cooler.

However, the air-cooled systems have lower cooling performance due to the limitations of convective heat transfer coefficients compared to cooling systems using liquid. Since the insufficient cooling performance significantly raises the battery temperature, the air-cooled BESSs are often exposed to high-temperature environments above 30° C. As a result, due to uneven heat transfer and low heat capacity of air, there are significant temperature differences between cells and between modules, thus adversely affecting the battery's durability and safety.

To overcome the above problems, water-cooled BESS systems have recently been developed. Such water-cooled BESS systems are divided into a direct water-cooled type where coolant cools the battery by being in direct contact with the battery through a cooling channel, and an indirect water-cooled type where the coolant cools the battery without the indirect contact with the battery by placing aluminum fins and thermal interface materials (TIMs) between the battery and the coolant.

In this instance, the direct water-cooled type has the advantage of superior cooling performance by directly contacting the battery but it is highly vulnerable to fire risks caused by leakage.

Moreover, the indirect water-cooled type achieves excellent cooling performance using forced convection of water but is complicated in structure and expensive compared to the air-cooled type. Additionally, the indirect water-cooled type offers better leakage stability compared to direct water-cooled type but still cannot entirely eliminate the possibility of leaks. Therefore, reliable measures to prevent coolant leakage are essential.

### SUMMARY OF THE DISCLOSURE

Accordingly, the present disclosure has been made to solve the above-mentioned problems occurring in the prior arts, and it is an objective of the present disclosure to provide a leakage detection liquid collector and a battery leakage detection system including the same, a leakage detection liquid collector which can collect and detect fluid leaking from a battery module at a specific point, effectively preventing the fluid from spreading to the battery module or surrounding areas, thereby avoiding battery performance degradation or accidents caused by the leakage.

The objectives of the present disclosure are not limited to those mentioned above, and other objectives not mentioned herein will be clearly understood by those skilled in the art from the following description.

To accomplish the above objective, according to the present disclosure, there is provided a leakage detection liquid collector for detecting fluid leakage from a battery module including: a collection unit detachably coupled to the bottom of a battery module and having a sloping surface formed toward the center to form a collection space where leaked fluid is gathered at the center thereof; and a sensing unit provided inside the collection unit to detect the fluid collected in the collection space.

In this instance, the collection unit includes: a drain hole located at the center of the collection unit where the leaked fluid is collected so that a predetermined area of the center thereof is opened; and a drain cover provided on the outside of the bottom of the collection unit, coupled to surround the drain hole, and having a space for collecting the fluid entering through the drain hole.

Moreover, the drain cover further comprises a contact unit extending along an end of the circumference thereof and in close contact with the outer surface of the collection unit in a face-to-face manner to seal the drain hole.

In this instance, the collection unit further comprises a coupling module for coupling the drain cover to the collection unit.

Furthermore, the coupling module includes: a hole unit extending from one end of the drain hole and having a fastening hole; and a fastening unit provided on the drain cover and having a protrusion formed on one side to selectively engage with the hole unit.

In this instance, the sensing unit is provided inside the drain cover to detect the fluid collected in the drain leakage from the battery module in the collection space.

Additionally, the collection unit has a water-repellent coating on the sloping surface to facilitate the smooth flow of leaking fluid into the center of the collection space.

In this instance, the leakage detection liquid collector further includes a support plate provided between the battery module and the collection unit and supporting the load of the battery module, wherein the support plate includes a plurality of perforations to facilitate the smooth flow of the fluid leaking from the battery module into the collection space.

In addition, the leakage detection liquid collector further includes a plate-shaped thermal interface material (TIM) provided on an upper portion of the collection unit and connected to the collection unit to allow the fluid leaking from the battery module to flow exclusively toward the collection unit.

In this instance, the leakage detection liquid collector further includes a pair of fixing units, of which one end is coupled to the collection unit and an opposite end is coupled to the battery module, preventing unintended movement of the battery module placed on the collection unit.

Moreover, the leakage detection liquid collector further includes a pair of support units provided at the underside ends of both sides of the collection unit to elevate collection unit at a certain height above the ground.

In another aspect of the present disclosure, there is provided a battery leakage detection system including: a battery module including a cell module, which is defined by assembling a plurality of unit cells, and a heat exchange unit, which is positioned below the cell module and in which fluid flows to maintain a constant temperature; and a leakage detection liquid collector on which the battery module is placed, and which collects and detects leaked fluid if fluid leaks from the heat exchange unit. The leakage detection liquid collector includes: a collection unit detachably coupled to the bottom of the battery module, having a sloping surface formed toward the center thereof, to form a collection space for collecting the fluid leaking from the heat exchange unit at the center thereof; and a sensing unit provided inside the collection unit to detect the fluid collected in the collection space.

Furthermore, the leakage detection liquid collector includes a support plate provided between the battery module and the collection unit, supporting the load of the battery module placed thereon and preventing unintended movement of the heat exchange unit. The support plate includes a plurality of perforations to facilitate the smooth flow of the fluid leaking from the heat exchange unit into the collection space.

In this instance, the leakage detection liquid collector further includes a plate-shaped TIM which is provided between the cell module and the heat exchange unit to transfer heat generated by the heat exchange unit to the cell module, and if the fluid leaks from the heat exchange unit, prevents the leaked fluid from being introduced into the cell module, thus allowing the leaked fluid to flow exclusively toward the collection unit.

Additionally, the leakage detection liquid collector further includes a pair of fixing units, of which one end is coupled to the collection unit and an opposite end is coupled to the battery module to prevent unintended movement of the battery module placed on the collection unit.

In addition, the leakage detection liquid collector further includes a pair of support units provided at the lower ends of both sides of the collection unit to space collection unit at a certain height above the ground.

As described above, according to the present disclosure, the leakage detection liquid collector and the battery leakage detection system including the same provide the following advantages.

First, the leakage detection liquid collector and the battery leakage detection system can collect and detect fluid leaking from the heat exchange unit of the battery module at a specific point, effectively preventing the fluid from spreading to the battery module, thereby avoiding battery performance degradation or accidents caused by the leakage.

Second, the leakage detection liquid collector and the battery leakage detection system can detect leakage with only the single fluid detection sensor, thereby simplifying the structure and enabling easy maintenance.

The effects of the present disclosure are not limited to the above-mentioned effects, and other effects, which are not specifically described herein, will be clearly understood by those skilled in the art from the following description.

### BRIEF DESCRIPTION OF THE DRAWINGS

FIG. 1 is an exemplary diagram illustrating the structure of a battery leakage detection system including a leakage detection liquid collector according to an embodiment of the present disclosure.

FIG. 2 is an exemplary diagram illustrating the leakage detection liquid collector according to an embodiment of the present disclosure.

FIG. 3 is an exploded perspective view illustrating the leakage detection liquid collector according to an embodiment of the present disclosure.

FIG. 4 is an exploded perspective view illustrating a leakage detection liquid collector according to another embodiment of the present disclosure.

FIG. 5 is an exemplary diagram illustrating an installation process of the battery leakage detection system according to an embodiment of the present disclosure.

FIG. 6 is an exemplary diagram illustrating the coupling relationship between a collection unit and a sensing unit in the leakage detection liquid collector according to an embodiment of the present disclosure.

### DETAILED DESCRIPTION OF THE PREFERRED EMBODIMENT

Hereinafter, preferred embodiments of the present disclosure, through which the objectives of the present disclosure can be concretely realized, will now be described with reference to the accompanying drawings. In the description of the embodiments, the same components refer to the same names and reference numerals, and repeated description thereof will be omitted.

Additionally, the present disclosure is disclosed as the result of a site-specific technical development agreement conducted by Korea Midland Power Co., Ltd. as the project manager, with Ajou University Industry-Academic Cooperation Foundation and Younghwa Tech Co., Ltd. participating as executing entities, researched from Dec. 23, 2022, to Dec. 22, 2024 under the project titled “Development of water-cooled thermal management system to improve durability and safety of battery energy storage system”.

The present disclosure relates to a leakage detection liquid collector and a battery leakage detection system including the same, which can collect and detect fluid leaking from a battery module to prevent degradation in battery performance or accidents caused by the leakage.

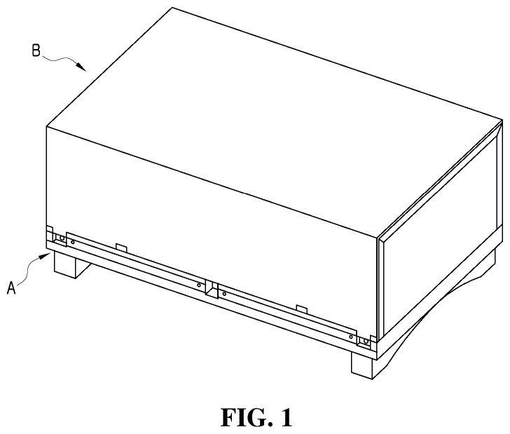

The battery leakage detection system according to the present disclosure is configured, if fluid (coolant) flowing inside a heat exchange unit 700 maintaining a consistent temperature of a cell module in the battery module B leaks, to collect the leaked fluid at a specific point to prevent the leaked fluid from entering other devices inside or outside the battery module B, detect the presence of the leaked fluid, determine whether a leak has occurred, and cut off the power to the battery module B. As illustrated in FIG. 1, the battery leakage detection system includes a leakage detection liquid collector A located beneath the battery module B.

In this instance, since the battery module B is a conventional technology, a detailed description of the battery module will be omitted.

According to an embodiment of the present disclosure, the leakage detection liquid collector A, which is designed to collect and detect the leakage of fluid flowing from the battery module B, includes: a collection unit 100 which is coupled to the bottom of the battery module B and has a sloping surface formed toward the central portion to form a collection space where the leaked fluid is gathered at the central portion; a support plate 200 which is positioned between the battery module B and the collection unit 100 to support the load of the battery module B; a plate-shaped thermal interface material (TIM) 300 which is provided on an upper portion of the collection unit 100 and connected to the collection unit 100 to allow the fluid leaking from the battery module B to flow only to the collection unit 10 without flowing into the battery module B or flowing to the sides of the battery module B; and a sensing unit 400 which is provided inside the collection unit 100 to detect fluid collected in the collection space.

In this instance, the collection unit 100 can be detachably coupled to the bottom of the battery module B for easy replacement, but is not limited to the above. The collection unit 100 may be integrally coupled to the bottom of the battery module B for more stable functionality.

The battery leakage detection system, which includes the leakage detection liquid collector A with the aforementioned structure, is fundamentally composed of the battery module B and the leakage detection liquid collector A installed at the bottom of the battery module B. The detailed configuration of following sections provides a more detailed description of the leakage detection liquid collector A, and the battery module B will be described in more detail.

According to an embodiment of the present disclosure, the battery leakage detection system may include: a battery module B including a cell module, which is formed by assembling a plurality of unit cells, and a heat exchange unit 700, which is positioned below the cell module and in which fluid flows to maintain a constant temperature; and a leakage detection liquid collector A, which is placed on the top of the battery module B and collects and detects leaked fluid if the fluid leaks from the heat exchange unit 700.

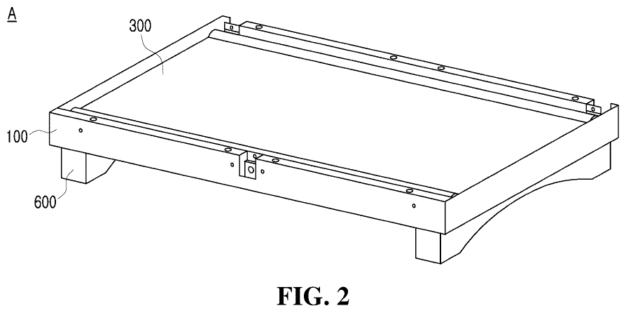

As illustrated in FIGS. 2 through 4, the leakage detection liquid collector A includes: a collection unit 100 which is coupled to the bottom of the battery module B and has a sloping surface formed toward the center to form a collection space which enables the fluid leaking from the heat exchange unit 700 to be introduced into the collection unit and to be accumulated at a specific point of the center; a support plate 200 which is provided above the collection space, supports the load of the cell module and the heat exchange unit 700, and secures the heat exchange unit 700 in a fixed position; a plate-shaped TIM 300 which is provided between the cell module and the heat exchange unit 700 to transfer heat (or cold heat) generated by the heat exchange unit 700 to the cell module, and, if the fluid leaks from the heat exchange unit 700, prevents the leaked fluid from being introduced into the cell module, namely, into the battery module B, thus allowing the leaked fluid to flow only toward the collection unit 100; and a sensing unit 400 which is provided inside the collection unit 100 to detect the fluid collected in the collection space and detect whether leakage has occurred in the heat exchange unit 700.

In this instance, the collection unit 100 is detachably coupled to the bottom of the battery module B, allowing for easy replacement, but is not limited thereto. The collection unit 100 may be integrally coupled to the bottom of the battery module B to ensure more stable functionality of the collection unit 100.

In this instance, the TIM 300 is preferably made of a silicone-based material mixed with silica or alumina to enhance thermal conductivity and maintain insulation and waterproof properties, thereby allowing heat generated from the heat exchange unit 700 to be smoothly transferred to the cell module and effectively preventing the fluid leaked from the heat exchange unit 700 from flowing into the cell module.

Additionally, the collection unit 100 may include: a drain hole 110 formed at the central portion where the fluid leaking from the heat exchange unit 700 of the battery module B provided on the top of the leakage detection liquid collector A is collected into the collection space so that a predetermined area of the center thereof is opened; and a drain cover 120 provided on the outside of the bottom of the collection unit 100, coupled to surround the drain hole 110, and including a space where the fluid introduced through the drain hole 110 is collected.

In this instance, the drain cover 120 may further include a contact unit 130 extending along an end of the circumference thereof and being in close contact with the outer surface of the collection unit in a face-to-face manner to seal the drain hole 110, preventing the fluid collected in the drain cover 120 from leaking outside the collection unit 100.

For example, the collection unit 100 has a sloping surface which is formed toward the central portion, and the drain hole 110 for opening the predetermined area of the center thereof. The drain cover 120 is positioned on the outer surface of the collection unit 100 to cover the drain hole 110, so that the leaked fluid introduced into the collection unit 100 can flow down toward the drain hole 110 along the sloping surface and can be collected into the drain cover 120 through the drain hole 110. In this instance, the drain cover 120 is extended along the circumference of an end being in close contact with the outer surface of the collection unit 100 in a face-to-face manner to form the contact unit 130 ensures face-to-face adherence, thus preventing the fluid collected in the drain cover 120 from leaking to the outside of the collection unit 100 through a gap between the drain cover 120 and the collection unit 100.

In this instance, a sealing unit (not shown) may be further provided between the contact unit 130 and the collection unit 100 to ensure the drain hole 110 is completely sealed. The sealing unit is made in the form of a pad to seal the drain hole 110 and absorb and distribute the pressure generated when the drain cover 120 is coupled to the collection unit 100, thereby preventing damage to the drain cover 120, the contact unit 130, and the collection unit 100.

The drain cover 120 may be detachably provided to the collection unit 100 to allow selective removal of the collected fluid, but is not limited thereto. If there is a fluid leakage, the drain cover may be structurally released from the collection unit to precisely identify the leakage point and take follow-up measures. Therefore, the drain cover 120 is preferably integrally coupled to the outer surface of the collection unit 100 to ensure stable collection functionality.

To achieve the objectives, the drain cover 120 is preferably welded to the outer surface of the collection unit 100 to ensure a more stable seal between the drain cover 120 and the collection unit 100.

For example, a coupling module 140 may be further provided to enable the drain cover 120 to be coupled to the collection unit 100. The coupling module 140 may include: a hole unit 141 extending from one end of the drain hole 110 and having a fastening hole formed on one side; and a fastening unit 142 provided on the drain cover 120 and having a protrusion which can selectively engage with the hole unit 141.

In more detail, the hole unit 141 may include a plate extending along the inner circumference of the drain hole 110 and bent at a certain angle toward the interior of the drain cover 120 and a fastening hole penetrating one side of the plate, and the fastening unit 142 may include a base protruding from the inner bottom surface of the drain cover 120 and a protrusion formed on one end of the base to fit into the fastening hole, such that the drain cover 120 can be coupled to the collection unit 100 to accommodate and cover the drain hole 110.

In this instance, it is preferable that at least one of the plates and the base has inherent elasticity to facilitate smoother coupling between the hole unit 141 and the fastening unit 142.

In addition, the coupling module 140, as described above, may adopt a buckle-type fastening mechanism. Alternatively, the coupling module 140 may have a welded part where the drain cover 120 and the collection unit 100 are welded to be coupled integrally, thus enhancing the sealing force between the drain cover 120 and the collection unit 100.

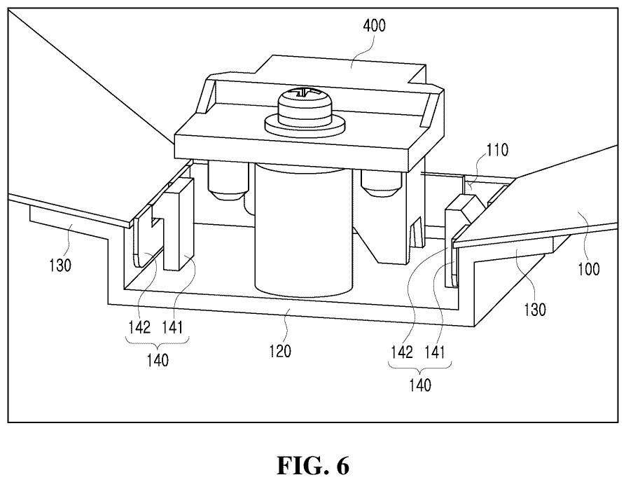

The detailed structure of the drain cover 120 and the structure of the coupling module 140, which allows the drain cover 120 to be detachably coupled to the collection unit 100, can be better understood with reference to FIG. 6.

According to an embodiment of the present disclosure, the sensing unit 400, which detects the fluid collected in the collection unit 100 and detects whether there is any leakage, is preferably positioned inside the drain cover 120 to detect the fluid collected in the drain cover 120, as illustrated in FIG. 6, thus enabling the detection of leaks in the heat exchange unit 700.

The sensing unit 400 may include a sensor module fixed inside the drain cover 120 using bolts to detect changes in resistance values as fluid gradually accumulates inside the drain cover 120 compared to when no fluid is present, thus determining whether a leak has occurred in the heat exchange unit 700.

Furthermore, the surface of the sloping surface of the collection unit 100 preferably has a water-repellent coating to allow the fluid leaked from the heat exchange unit 700 to flow smoothly toward the central portion along the sloping surface, namely, toward the drain hole 110 and the drain cover 120 formed at the center of the collection unit 100.

In this instance, the support plate 200 preferably has a plurality of perforations to ensure that the fluid leaking from the heat exchange unit 700 placed on the top can flow smoothly into the collection space of the collection unit 100 located below the support plate 200. The leaked fluid dropping and introduced into the collection unit 100 through the perforations flows along the sloping surface of the collection unit 100 to be collected into the drain cover 120.

According to an embodiment of the present disclosure, the leakage detection liquid collector A may further include a pair of fixing units 500 positioned on both sides of the collection unit (100). One side of each fixing unit is bolted to the collection unit (100), while the other side is attached to the battery module (B). This configuration prevents the battery module (B), placed on top of the collection unit (100), from being unintentionally moved. The fixing units 500 also ensure that the battery module B is firmly fixed, and maintain the stability of the cell module, the TIM 300, the heat exchange unit 700, and the support plate 200 against external vibrations.

In this instance, the fixing units 500 can have any structure for stable coupling of the collection unit 100 and the battery module B. However, for more stable coupling, it is preferable for the fixing units to be a bar with a predetermined length bent in an ‘L’ shape, thereby providing enhanced binding force between the leakage detection liquid collector A and the battery module B.

Rather than integrally coupling the leakage detection liquid collector A and the battery module B using the fixing units 500, it is preferable for the fixing units to couple the leakage detection liquid collector A and the battery module B using bolts, enabling easy detachment.

According to an embodiment of the present disclosure, the leakage detection liquid collector A may further include a pair of support units 600 provided at the underside ends of both sides of the collection unit 100 to space collection unit 100 at a certain height above the ground.

Lower portions of the support units 600 protrude outward, namely, toward the ground surface since the collection unit 100 forms the sloping surface, so can prevent difficulty in arrangement and installation caused by the uneven lower surface of the collection unit 100. Additionally, since the leakage detection liquid collector A can be stably arranged and installed on a horizontal plane relative to the ground, such that the fluid leaking from the heat exchange unit 700 flows stably along the sloping surface of the collection unit 100 without pooling on one side.

Additionally, the support units 600, positioned at the lower ends of both sides of the collection unit 100, distribute the load applied to the top of the collection unit 100 and transfer to the ground (which means the installation surface of the leakage detection liquid collector), thus reducing the stress applied to the collection unit 100.

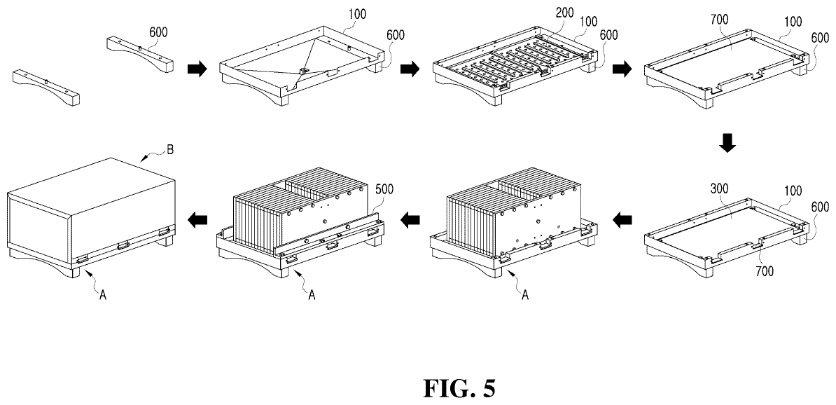

Referring to FIG. 5, an installation process of the leakage detection liquid collector and the battery leakage detection system according to the present disclosure can be better understood.

In this instance, the heat exchange unit 700 may have a cooling plate structure with fluid flowing through flow channels formed in aluminum panels, but is not limited thereto. The heat exchange unit 700 may have a panel structure where a plurality of microtubes, through which fluid flows, are arranged in a continuous parallel configuration. Depending on the structure of the heat exchange unit 700, the surface of the support plate 200, which prevents the heat exchange unit 700 from moving unintentionally, more specifically, the surface of the support plate 200, which is in close contact with the heat exchange unit 700, may have a varying shape.

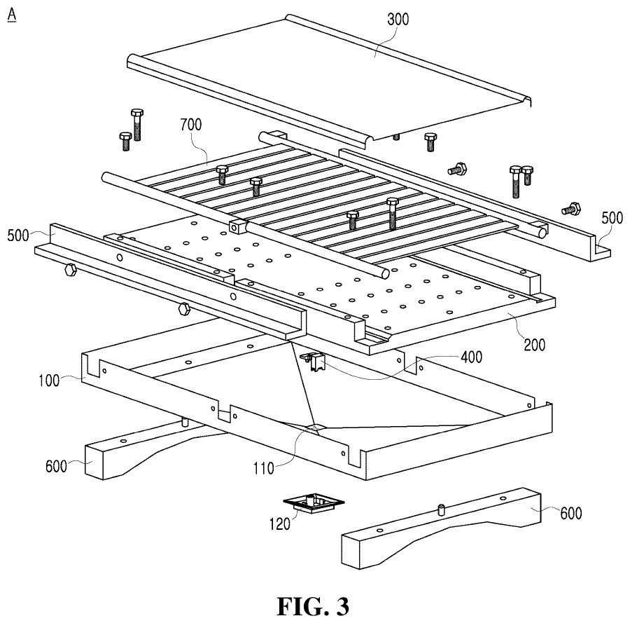

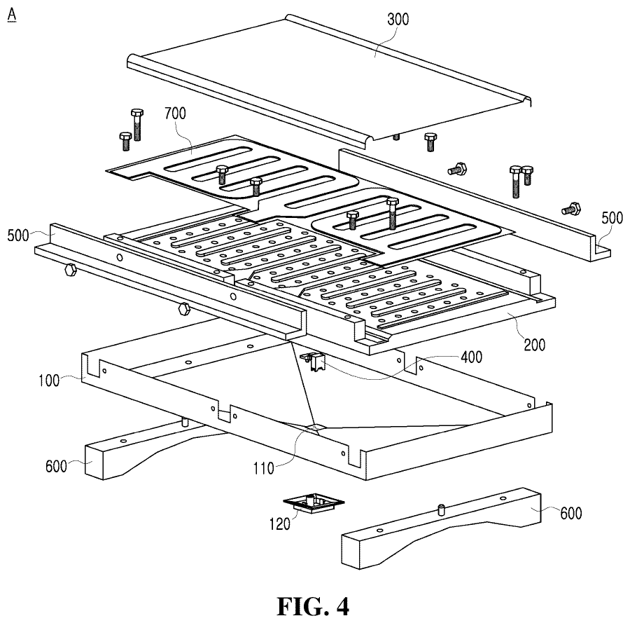

Referring to FIGS. 3 and 4, the structural design of the heat exchange unit 700 and the corresponding support plate 200 according to the embodiments of the present disclosure can be better understood.

As described above, while the preferred embodiments of the present disclosure have been described, it will be apparent to those skilled in the art that the present disclosure can be implemented in other specific forms without departing from the spirit or essential characteristics. Therefore, the above-mentioned embodiments should be considered as illustrative, not restrictive, and the present disclosure may be modified within the scope and equivalence of the appended claims.

What is claimed is:

1. A leakage detection liquid collector for detecting fluid leakage from a battery module, the leakage detection liquid collector comprising:
a collection housing detachably coupled to a side of the battery module, and the collection housing having a sloping surface defined toward a center thereof, the collection housing having a collection space therein; and
a sensor detecting the fluid leakage from the battery module in the collection space.

2. The leakage detection liquid collector of claim 1, wherein the collection housing comprises:
a drain hole defined at the center of the collection housing where the fluid leakage from the battery module is collected, the drain hole is defined to open a predetermined area in the center of the collection housing; and
a drain cover disposed on outside of one side of the collection housing, coupled to surround the drain hole, and having a space collecting the fluid leakage from the battery module entering through the drain hole.

3. The leakage detection liquid collector of claim 2, wherein the drain cover further comprises a contact surface extending along an end of a circumference of the drain cover and being in close contact with outer surface of the collection housing in an area-to-area contact manner to seal the drain hole.

4. The leakage detection liquid collector of claim 2, wherein the collection housing further comprises a coupling module coupling the drain cover to the collection housing.

5. The leakage detection liquid collector of claim 4, wherein the coupling module comprises:
a receptacle housing extending from one end of the drain hole and defining a fastening hole; and
a fastening anchor disposed on the drain cover and having a protrusion defined on one side to selectively engage with the receptacle housing.

6. The leakage detection liquid collector of claim 2, wherein the sensor is provided inside the drain cover to detect the fluid leakage from the battery module in the collection space.

7. The leakage detection liquid collector of claim 1, wherein the collection housing has a water-repellent coating on the sloping surface to facilitate smooth flow of the fluid leakage from the battery module toward a center of the collection space.

8. The leakage detection liquid collector of claim 1, further comprising:
a support plate disposed between the battery module and the collection housing the support plate supporting a weight of the battery module,
wherein the support plate includes a plurality of perforations to facilitate the fluid leaking from the battery module into the collection space.

9. The leakage detection liquid collector of claim 1, further comprising:
a plate-shaped thermal interface material (TIM) disposed on an upper structure of the collection housing and connected to the collection housing to direct fluid leakage from the battery module to flow exclusively toward the collection housing.

10. The leakage detection liquid collector of claim 1, further comprising:
a pair of fixers of which one end is coupled to the collection housing and an opposite end is coupled to the battery module preventing unintended movement of the battery module placed on the collection housing.

11. The leakage detection liquid collector of claim 1, further comprising:
a pair of supporters disposed at underside ends of both sides of the collection housing to elevate the collection housing to a certain height above ground.

12. A battery leakage detection system comprising:
a battery module including a cell module, which is defined by assembling a plurality of unit cells;
a heat exchanger, positioned below the cell module to circulate a fluid leakage from the battery module to maintain a constant temperature; and
a leakage detection liquid collector positioned beneath the battery module, configured to collect and detect fluid leaking from the battery module,
wherein the leakage detection liquid collector comprises:
a collection housing detachably coupled to a side of the battery module, and the collection housing having a sloping surface defined toward a center thereof, the collection housing having a collection space therein; and
a sensor detecting the fluid leakage from the battery module in the collection space.

13. The battery leakage detection system of claim 12, wherein the leakage detection liquid collector comprises a support plate disposed between the battery module and the collection housing, the support plate supporting a weight of the battery module placed thereon, and preventing unintended movement of the heat exchanger, and
wherein the support plate includes a plurality of perforations to facilitate fluid flow from the heat exchanger into the collection space.

14. The battery leakage detection system of claim 12, wherein the leakage detection liquid collector further comprises:
a plate-shaped TIM which is disposed between the cell module and the heat exchanger transferring heat generated by the heat exchanger to the cell module, and preventing the fluid leakage from the battery module from entering the cell module, having the fluid leakage from the battery module to flow exclusively toward the collection housing.

15. The battery leakage detection system of claim 12, wherein the leakage detection liquid collector further comprises a pair of fixers, of which one end is coupled to the collection housing and an opposite end is coupled to the battery module, preventing unintended movement of the battery module placed on the collection housing.

16. The battery leakage detection system of claim 12, wherein the leakage detection liquid collector further comprises a pair of supporters disposed at underside ends of both sides of the collection housing to elevate the collection housing to a predetermined height above ground.
